(19) United States
(12) Patent Application Publication
(10) Pub. No.: US 2016/0249424 A1
(43) Pub. Date: Aug. 25, 2016

(54) MULTIPLE INPUT LED DRIVER

(71) Applicant: LUXTECH, LLC, Philadelphia, PA (US)

(72) Inventors: Sean R. DARRAS, Philadelphia, PA (US); Ronald J. LENK, Marietta, GA (US)

(73) Assignee: LuxTech, LLC, Philadelphia, PA (US)

(21) Appl. No.: 15/027,217

(22) PCT Filed: Dec. 4, 2014
(86) PCT No.: PCT/US14/68584

§ 371 Date: Apr. 4, 2016

Related U.S. Application Data
(60) Provisional application No. 61/887,347, filed on Oct. 5, 2013.

(51) Int. Cl. H05B 33/08

(52) U.S. Cl. CPC H05B 33/0827; H05B 33/0809

(57) ABSTRACT

A universal AC-line input light emitting diode (LED) drive that automatically transitions to the most favorable configuration of the LEDs based on the particular range of line voltage input applied.

### CROSS-REFERENCE TO RELATED APPLICATIONS

The present application claims priority to U.S. Provisional Patent Application No. 61/887,347, filed Oct. 5, 2013. The contents of that patent application are hereby incorporated by reference.

### FIELD OF THE INVENTION

The present invention relates to providing a multiple-voltage-range AC-line input light emitting diode (LED) driver, and more particularly, to making a driver that automatically transitions to the most favorable configuration of the LEDs based on the particular range of line voltage input applied.

### BACKGROUND OF THE INVENTION

It is frequently desirable to power LEDs from the AC line. In North America, this is nominally 120 VAC or 277 VAC; in other parts of the world, this is nominally 240 VAC. The actual line voltage may deviate from these nominal values by ±10% or more on a regular basis.

LEDs typically have a forward voltage while conducting current of approximately 3 V. This voltage varies somewhat as a function of the drive current and temperature, typically ±20%. However, LEDs, being diodes, need to be driven with a current rather than a voltage. For this reason, LEDs are frequently driven by switch-mode power supplies (SMPS), which convert the high-voltage AC line voltage to a low-voltage current.

However, SMPS tend to be expensive, and may have relatively low lifetime compared with that of the LEDs they are driving. For this reason, some designs use a string of LEDs, with a sufficient number of LEDs in series in the string to present a forward voltage of approximately the line voltage. Some designs place the LED string directly across the AC line; however, since LEDs are unidirectional, the LEDs in this arrangement conduct only during half of each line cycle. Other designs first rectify the AC line and then apply the rectified voltage to the string of LEDs; in this arrangement, the LEDs conduct during both halves of the line cycle, thus providing double the light output of the first configuration.

However, such designs suffer from a number of problems. The most important of these is that as the line voltage increases above nominal, the LED current also increases. The increase in LED current may be so large that only a small voltage increase by the line may be enough to cause destructive current to flow through the LEDs.

A related problem is that such designs cannot operate from multiple line voltage input ranges. They must be tailored to produce the right current (and thus the right light output) for a single line voltage. Operation at different ranges of line voltage, as would be desirable for a universal input voltage light, might cause failure.

It would be desirable to have an AC drive circuit which controls the maximum current through the LEDs without affecting efficiency, and thus can operate on multiple line input voltage ranges. It would also be desirable that it would be inexpensive and have a long lifetime.

### SUMMARY OF THE INVENTION

This invention has the object of developing an AC-line driver for LEDs, such that the above-described primary problem is effectively solved. It aims at providing an AC-line driver for LEDs that produces a certain current at a specified average line voltage, and which if driven by a different specified average line voltage, re-configures to produce another certain current at that other specified average line voltage. It also provides for high efficiency, low cost and long lifetime. The invention includes a rectifier bridge and two sets of strings of LEDs. The first set of strings is connected from the output of the bridge, through a controllable element such as a transistor or a current sink, to ground.

The second set of strings of LEDs is connected through a transistor to the output of the bridge, and is then connected to ground, either directly or through a controllable element such as a transistor or a current sink. The output of the first set of strings of LEDs is, in addition to being connected to a controllable element, also connected to a diode, and potentially also to additional components as described below, which in turn connects to the input of the second set of strings of LEDs.

If the input voltage is at a first, lower, average input voltage range, the controllable element for the first set of strings of LEDs is on, as is also the controllable element from the output of the bridge to the input to the second set of strings of LEDs. The controllable element for the second set of strings of LEDs, if present, is also on in this configuration. In this configuration, both sets of strings of LEDs are effectively connected in parallel to the output of the bridge, and are both powered on. In one embodiment, the strings and controllable elements are designed to be such that a specific current is produced at the first average input voltage range.

If the input voltage is at a second, higher, average input voltage range, the controllable element for the first set of strings of LEDs is off, as is also the controllable element from the output of the bridge to the input to the second set of strings of LEDs. The controllable element for the second set of strings of LEDs, if present, remains on in this configuration. In this configuration, the current from the bridge goes through the first set of strings of LEDs, through the diode, and through the additional components if present, and then through the second set of strings of LEDs, and then to ground, either directly or through the controllable element for the second set of strings of LEDs, if present. In one embodiment, the first input voltage range is nominally 120 VAC and the second input voltage range is nominally 240 VAC.

The second nominal line voltage may also be more than double the voltage of the first line voltage. In this case, in an embodiment, the diode may have an additional set of strings of LEDs in series with it, to compensate for the difference in voltage between twice the first nominal input voltage and the second nominal input voltage. In an embodiment, this compensation may also be or include a resistor or set of resistors, and/or a zener or a set of zeners. In an exemplary embodiment, the compensation may consist of only a resistor or set of resistors, without the additional set of strings of LEDs. The additional set of strings of LEDs, resistors and/or zeners may be designed to be such that the series combination of the first, second and additional set of strings of LEDs, resistors and/or zeners produces a specific current at the second nominal line voltage.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention.

FIG. 1 is a diagram of an AC-line input LED circuit, in which two sets of strings of LEDs are configured to run from either a low line voltage range or a high line voltage range.

FIG. 2 is a diagram of an AC-line input LED circuit, operating from a low line-voltage range.

FIG. 3 is a diagram of an AC-line input LED circuit, operating from a high line-voltage range.

### DESCRIPTION OF THE PREFERRED EMBODIMENT

Reference will now be made in detail to the present preferred embodiments of the invention, an example of which is illustrated in the accompanying drawing. Wherever possible, the same reference numbers are used in the drawing and the description to refer to the same or like parts.

According to the design characteristics, a detailed description of the preferred embodiment is given below.

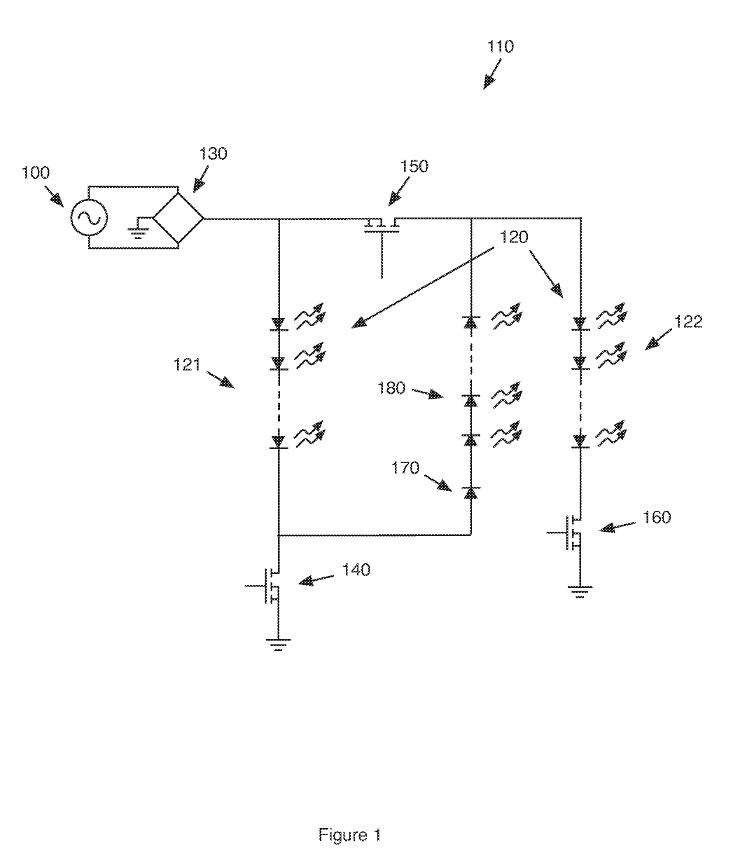

FIG. 1 is a diagram of an AC-line 100 input LED circuit 110, in which two sets of strings of LEDs 120 are configured to run from either a low line voltage range or a high line voltage range. As shown in FIG. 1, the AC-line 100 is rectified by a diode bridge 130. The output voltage of the diode bridge 130 is fed to the first 121 of the two sets of strings of LEDs 120. This first 121 of the two sets of strings of LEDs 120 is connected through a transistor 140 to ground. In other embodiments, the transistor 140 may be utilized as, or replaced by, a current sink. The output voltage of the diode bridge 130 is also fed to the transistor 150, and then to the second 122 of the two sets of strings of LEDs 120. The second 122 of the two sets of strings of LEDs 120 is connected through a transistor 160 to ground, although the transistor 160 need not be present in all cases. In other embodiments, the transistor 160 may be utilized as, or replaced by, a current sink.

The connection of the first 121 of the two sets of strings of LEDs 120 to the transistor 140 is also connected to a diode 170. The diode 170 is connected to a third set of strings of LEDs 180, although this third set of strings of LEDs 180 may not be present in all cases. The third set of strings of LEDs 180 may instead be replaced by or supplemented by one or more resistors and/or one or more zener diodes. The third set of strings of LEDs 180 is then connected to the connection between the transistor 150 and the second 122 of the two sets of strings of LEDs 120. If the third set of strings of LEDs 180 is not present, nor the one or more resistors and/or one or more zener diodes, then the diode 170 is instead connected directly to the connection between the transistor 150 and the second 122 of the two sets of strings of LEDs 120.

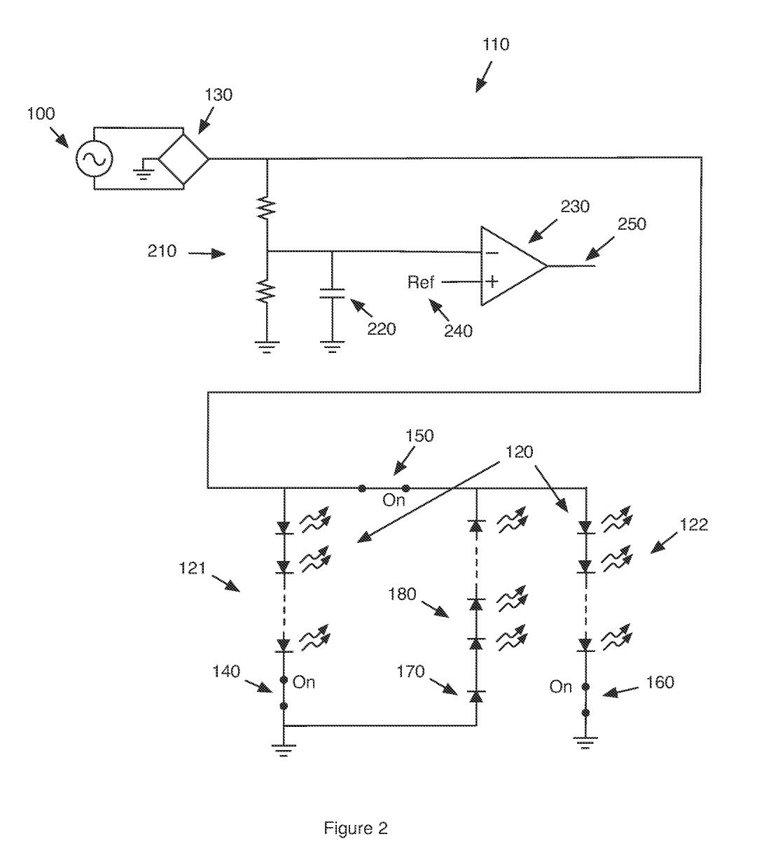

FIG. 2 is a diagram of an AC-line 100 input LED circuit 110, operating from a low line-voltage range. As shown in FIG. 2, the output voltage of the diode bridge 130 is divided down by a resistor divider 210. The divided down voltage is averaged by the RC circuit formed by the resistor divider 210 and the capacitor 220. The time constant formed by the RC circuit formed by the resistor divider 210 and the capacitor 220 will preferably be several line cycles long. The averaged divided down voltage is compared by a comparator 230 with a reference voltage 240. Since the line-voltage is in the low range, the averaged divided down voltage is designed to be lower than the reference voltage 240, and thus the comparator 230 has an output 250 which is high.

When the output 250 of the comparator 230 is high, all three transistors 140, 150, and 160 if present, are in their ‘on’ state, shown herein as a closed switch. Transistor 140 or a current sink connects the first 121 of the two sets of strings of LEDs 120 to ground, causing them to experience voltage equal to the line-voltage and conduct current. Transistor 150 connects the output voltage of the bridge 130 to the input of the second 122 of the two sets of strings of LEDs 120. Transistor 160 or a current sink, if present, connects the second 122 of the two sets of strings of LEDs 120 to ground. If transistor 160 or a current sink is not present, the second 122 of the two sets of strings of LEDs 120 may be connected directly to ground. As the second 122 of the two sets of strings of LEDs 120 is connected to the output of the bridge 130 and ground, they also experience voltage equal to the line-voltage, and so they also conduct current. Since the diode 170 and the third set of strings of LEDs 180 and/or resistors and/or zener diodes has the output of the bridge 130 and ground applied across them, the diode 170 is reverse-biased, and is non-conducting in this situation. Thus, the third set of strings of LEDs 180, if present, is off In this configuration, the two sets of strings of LEDs 120 are in parallel, thus producing the correct current in each string at the lower line-voltage range.

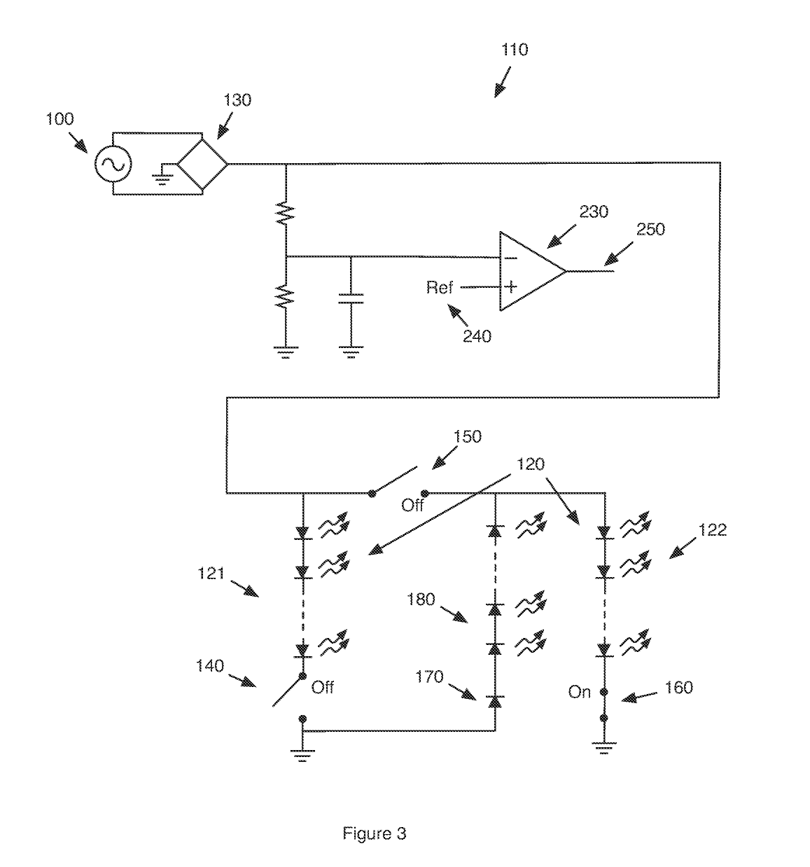

FIG. 3 is a diagram of an AC-line 100 input LED circuit 110, operating from a high line-voltage range. As shown in FIG. 3, since the line-voltage is in the high range, the averaged divided down voltage is designed to be higher than the reference voltage 240, and thus the comparator 230 has an output 250 which is low. When the output 250 of the comparator 230 is low, the transistors 140 and 150 are in their ‘off’ state, shown herein as open switches, while transistor 160 or a current sink, if present, is in its ‘on’ state, shown herein as a closed switch. In this condition, current flows through the first 121 of the two sets of strings of LEDs 120, through the diode 170, through the third set of strings of LEDs 180 and/or resistors and/or zener diodes if present, and then through the second 122 of the two sets of strings of LEDs 120 to the transistor 160 or current sink, if present, which is connected to ground. In this configuration, the two sets of strings of LEDs 120 are in series, thus producing the correct current at the higher line-voltage range.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A line-voltage LED driver comprising:
a rectifier;
a first at least one LED connected to an output of said rectifier;
a first controllable element in series with said first at least one LED;
a second at least one LED;
a second controllable element connected to said output of said rectifier and to said second at least one LED;
a connection from said second at least one LED to ground;
at least one unidirectional conducting element conducting from said connection of said first controllable element with said first at least one LED to said connection of said second controllable element with said second at least one LED; and
a control system controlling said first controllable element and said second controllable element such that both are on if the average line voltage is in one range of line-voltages, and are both off if the average line voltage is in a second range of line-voltages.

2. A line-voltage LED driver as set forth in claim 1, wherein said rectifier is a diode bridge rectifier.

3. A line-voltage LED driver as set forth in claim 1, wherein said first at least one LED is at least one series string of LEDs.

4. A line-voltage LED driver as set forth in claim 1, wherein said first controllable element is a transistor.

5. A line-voltage LED driver as set forth in claim 1, wherein said first controllable element is a current sink.

6. A line-voltage LED driver as set forth in claim 1, wherein said second at least one LED is at least one series string of LEDs.

7. A line-voltage LED driver as set forth in claim 1, wherein said second controllable element is a transistor.

8. A line-voltage LED driver as set forth in claim 1, wherein said connection from said second at least one LED to ground is a short.

9. A line-voltage LED driver as set forth in claim 1, wherein said connection from said second at least one LED to ground comprises a third controllable element in series with said second at least one LED and connected to ground.

10. A line-voltage LED driver as set forth in claim 9, wherein said third controllable element is a transistor.

11. A line-voltage LED driver as set forth in claim 9, wherein said third controllable element is a current sink.

12. A line-voltage LED driver as set forth in claim 1, wherein said unidirectional conducting element is a diode.

13. A line-voltage LED driver as set forth in claim 12, wherein said diode is in series with a third at least one LED.

14. A line-voltage LED driver as set forth in claim 13, wherein said third at least one LED is at least one series string of LEDs.

15. A line-voltage LED driver as set forth in claim 14, wherein said at least one series string of LEDs contain fewer LEDs per string than said first or said second at least one LEDs.

16. A line-voltage LED driver as set forth in claim 12, wherein said diode is in series with at least one resistor.

17. A line-voltage LED driver as set forth in claim 12, wherein said diode is in series with at least one zener diode.

18. A line-voltage LED driver as set forth in claim 1, wherein said control system comprises an averaged, divided down version of the line voltage, a comparator, and a reference voltage, such that said averaged, divided down version of the line voltage is compared with said reference voltage by said comparator, said comparator then determining the state of said first controllable element and said second controllable element from said comparison.
